(19) United States
(12) Patent Application Publication
(10) Pub. No.: US 2010/0279567 A1
(43) Pub. Date: Nov. 4, 2010

(54) AIR-LAID NON-WOVEN FIBRE PRODUCT COMPRISING FIBRES OF RECYCLED MATERIAL

(75) Inventor: Carsten Andersen, Hasselager (DK)

Correspondence Address: CANTOR COLBURN, LLP, 20 Church Street, 22nd Floor, Hartford, CT, 06103, US

(73) Assignee: FORMFIBER DENMARK APS, Hasselager (DK)

(21) Appl. No.: 12/602,212

(22) PCT Filed: May 16, 2008
(86) PCT No.: PCT/DK2008/050108

§ 371 Date: Jun. 28, 2010

(30) Foreign Application Priority Data
Jun. 1, 2007 (DK) PA 2007 00798

(51) Int. Cl. D04H 1/54; B32B 5/02; D04H 1/72

(52) U.S. Cl. 442/136; 442/334; 264/123

(57) ABSTRACT

The present invention concerns an air-laid non-woven fibre product manufactured by a dry forming process, said product comprising a first portion of up to 98% recycled shredded material, where the shredded material is a mixture of shredded fabric material fibres from automotive tires or the like and residues of rubber and other components from the shredded tires, and a second portion of 1-30%, preferably 1-5%, bi-component fibres having a length between 2-50 mm, preferably 2-6 mm in length.

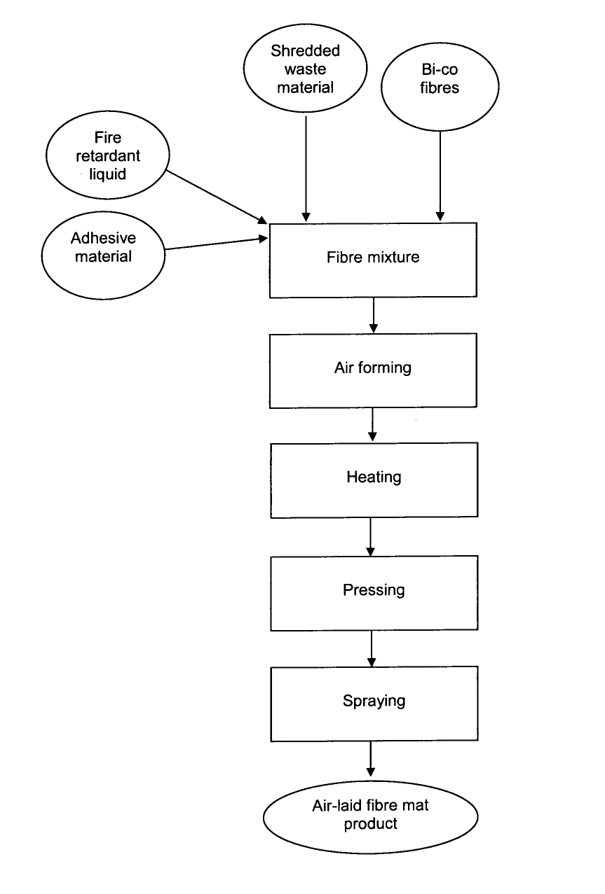

### CROSS REFERENCE TO RELATED APPLICATIONS

All patent and non-patent references cited in the present application are also hereby incorporated by reference in their entirety.

### TECHNICAL FIELD OF INVENTION

The present invention relates to air-laid non-woven fiber product manufactured by a dry forming process and a method of manufacturing such product.

From U.S. Pat. No. 5,516,580 an insulation batt is known, where the material contains a portion of cellulose fibers, and longer bonding synthetic fibers. These synthetic fibers are so-called bi-component fibers that have an outer sheath which is heat-fused with outer sheaths of other synthetic fibers at crossing contact points thereof to form a matrix having pockets for retaining loose fill cellulose fibers therein. This matrix eliminates the need of an adhesive binder to retain the cellulose fibers in the matrix.

The drawback of this insulation board is that the fiber batt obtained hereby is not particularly resilient and the use of longer bi-component synthetic bonding fibers makes the product very expensive to manufacture.

A method of making a resilient mat is known from U.S. Pat. No. 5,554,238. The insulation mat according to this method comprises cellulosic and thermoplastic fibers. A mat is formed in an air-laying process and subsequently the surface is flame-treated to melt the thermoplastic component on the surface forming a skin which keeps the cellulosic fibers intact. The thermoplastic fibers in the interior of the mat remains unmelted, whereby the mat is provided with a spring-back characteristic, which allows the mat to retain most of its original shape after it has been compressed, e.g. for shipping.

However, this resilient mat has a “crisp” exterior surface reducing the resiliency of the mat as a whole and not homogeneously bonded throughout the product, which does not allow for easy handling since the product may easily delaminate or otherwise break up. The insulation effect is moreover reduced due to the more compact structure of the fiber product.

From WO 01/48330 a recyclable insulating mat comprising shredded waste paper or cardboard mixed with natural fibers and 5-50% polyester is known.

In DE 196 02 551 C1, there is described a mat for manufacturing self-supporting form parts by heat treatment. The mat comprises long natural fibers and thermoplastic binding means provided as synthetic fibers. The thermoplastic binding means are provided synthetic material with a high melting point and a low melting point.

### BRIEF SUMMARY

The disclosure provides a resilient fibrous product which is recyclable and inexpensive to manufacture from waste material.

The disclosure further provides an air-laid non-woven fiber product manufactured by a dry forming process, said product comprising a first portion of up to 98% recycled shredded material, where the shredded material is a mixture of shredded fabric textile material fibers from automotive tires or the like and residues of rubber and other components from the shredded tires, and a second portion of 1-30%, preferably 1-5%, bi-component fibers having a length between 2-50 mm.

According to a second aspect of the invention, there is provided a method of manufacturing a non-woven product by dry forming a product of fibrous material, said method comprising the steps of advancing fibrous material into a forming box having a bottom outlet positioned over a forming wire to form a web of dry-laid fibers on the forming wire, where said fibrous material comprises a first portion of up to 98% recycled shredded material, where the shredded material is a mixture of shredded fabric material fibers from automotive tires or the like and residues of rubber and other components from the shredded tires, and a second portion of 1-30%, preferably 1-5%, bi-component fibers with a length between 2-50 mm and comprising a core and an outer sheathing, said outer sheathing having a first melting temperature which is lower than the second melting temperature of the core; heating the web of fibers formed on the forming wire to a temperature above the first melting temperature; and advancing the fibrous web through a pressing section whereby a fibrous product web with a predetermined density is formed.

According to the invention, an air-laid fibrous product is obtained based on recycled fibers from waste material from recycled tires. These tires are among the largest and most problematic sources of waste, due to the large volume produced and their durability. Those same characteristics which make waste tires such a problem also make them one of the most re-used waste materials, as the rubber is very resilient and can be reused in other products. Thus, the rubber of the scrap tires may be recycled, but by the present invention, it is realised that also the other material components of the scrap tires may be recycled.

When a scrap tire is to be recycled, the tires are shredded and the rubber components are separated from the rest of the waste material and collected for reuse in other products. However, the remaining waste material comprising shredded textile material cannot be recycled. This waste tires textile material also contains residues of rubber and metal wires.

By the invention, it is realised that the shredded tires fabric material can be recycled in an advantageous manner by utilising this material in an air-laid fiber mat which is obtainable by using the manufacturing technology disclosed in W02005/044529. The fiber mat product according to the invention is furthermore advantageous since the product is water repellent and provided with resilience whereby the mat raises again after compression and resumes its original shape.

This advantageous characteristic of the product according to the invention is also achieved by the use of short bi-component fibers so that the resulting fibrous mat is very flexible as the short bi-component fibers acting as binding means in the product are short. The bi-co fibers become hard when cured after having been heated above the melt temperature, so by using short bi-co fibers the bi-co fibers do not adversely affect the resulting product with respect to flexibility and elastic properties when cured due to their short length.

Moreover, it is realised by the invention that the short bi-component fibers mix better with the recycled fibers whereby a substantially small proportion of bi-co fibers are needed to provide sufficient coherence of the product. This further enhances the flexibility of the fibrous product.

### BRIEF DESCRIPTION OF THE DRAWING

The invention is further explained with reference to the accompanying drawing which shows a diagram of an embodiment of the manufacturing process for producing a product according to the invention.

### DETAILED DESCRIPTION

In a preferred composition of the fiber product, 80-90% recycled shredded tire material fibers are used together with 10-20% bonding fibers. The bonding fibers are bi-component fibers substituted or supplemented with polyester fibers, polypropylene and/or other plastic fibers having bonding characteristics.

The product according to the invention is found particularly advantageous since it is flexible and whether and water resistant and may thereby substitute e.g. foam sheets in the building industry. Other useful purposes may be vibration or noise damping, e.g. of wooden floors, use in noise screens in road constructions, etc.

Preferably, the fiber length of the shredded material in the first portion is 1-100 mm, and the grammar weight of the air-laid product according to the invention is between 20 kg/m³ and 200 kg/m³.

In an embodiment of the invention, addition fibers, such as recycled glass fibers, carbon fibers or the like, may be added to the first portion.

In a preferred embodiment of the invention, at least 50% of the bi-component fibers are crimped fibers with a length between 2 to 50 mm. By using short and crimped fibers, e.g. of a helical shape extra flexibility and resilience is achieved in the product allowing the product to appear softer and having good properties with respect to raising again after compression and resuming its original shape.

In a preferred embodiment, the fibers are provided with fire-retarding chemical, such as Borax, Boric acid, Ammonium sulphate or aluminium sulphate, mixed with the fibers, e.g. in the forming box before being laid on the forming wire. In another embodiment, the dry-formed fiber mat may be sprayed with fire-retarding chemical, e.g. after the mat is formed and heated.

If extra bonding of the fibers is required, an additional fluidized binder may be sprayed into the forming box and onto the fibers therein. The fluidized binder may alternatively be sprayed onto the fibers. As a further alternative or as a supplement, binder in pulverised form may be mixed with the fibers before the mixture is forwarded to the forming box.

Waste material from shredded tires mainly consisting of tire fabric shredded into fibers in a length below 100 mm. Although mainly consisting of fabric from the tires, the shredded waste fibers also contain residues of rubber and some pieces of metal wire which have not been recovered from the shredded tire material for immediate reuse.

This shredded fabric fiber material including residue material constitutes a first fiber portion which is mixed with bi-component fibers. These bi-component fibers comprise a core and an outer sheathing, said outer sheathing having a first melting temperature which is lower than the second melting temperature of the core. The purpose these bi-component fibers serve is to provide bonding between the fibers in the first portion of fibers. The bi-component fibers become hard when cured after having been heated above the melt temperature, so by using short bi-co fibers the bi-co fibers do not adversely affect the resulting product with respect to flexibility and elastic properties when cured due to their short length. Moreover, the short bi-component fibers blend very well with the fibers of the first portion ensuring a more homogeneous bonding throughout the product.

The mixture of fibers are forwarded to a forming box, preferably of the kind described in W02005/044529, where the box is provided with a revolving belt screen allowing for an even distribution of fibers irrespective of their size.

The fibers are introduced into the forming box and laid on the forming wire beneath the forming box. The web of fibers is forwarded in a continuous motion through a heating station where the bi-component fibers are activated and the fibrous web is provided with its coherence.

The web is then cured as the heated bi-component fibers are cooled and the web may be forwarded through a pressing station for providing the resulting mat product with a predetermined density.

The fibrous web may be sprayed with a fire-retarding substance, such as Borax, Boric acid, Ammonium sulphate or aluminium sulphate, for providing the product with fire-retarding properties. Alternative to spraying the formed web, this substance could also be sprayed into the forming box and thereby priming the fibers before the fibers are laid onto the forming wire.

### EXAMPLE:

### Example I:

A material for forming an insulation fiber mat is mixed by provided the following components:

90% shredded scrap tire fabric fibers of recycled tires.

10% bi-component fibers of approx. 6 mm length having a coated polyester core.

The fibers are laid by the forming box and heated to a temperature of 130° C. and then primed with a fire retardant.

Hereby, a cost effective fiber product having a grammar weight of 20-200 kg/m³ is provided, which has a good spring elastic effect and insulation properties.

By the present invention, it is realised that the variations of the above-mentioned example may be performed without departing from the scope of the invention as defined in the accompanying claims.

1. An air-laid non-woven fiber product manufactured by a dry forming process, said product comprising:
a first portion of up to 98% recycled shredded material, where the shredded material is a mixture of shredded fabric material fibers from automotive tires and residues of rubber and other components from the shredded tires, and a second portion of 1-30%, bi component fibers having a length between 2-50 mm.

2. A product according to claim 1, wherein at least a major portion of the bi-component fibers are crimped fibers with a length between 2 to 50 mm.

3. A product according to claim 1, wherein the fiber length of the shredded material in the first portion is 1-100 mm.

4. A product according to claim 1, wherein additional fibers, comprising recycled glass fibers and carbon fibers, may be added to the first portion.

5. A product according to claim 1, wherein the fibers are provided with fire-retarding chemical mixed with the fibers.

6. A product according to claim 1, wherein the dry-formed fiber mat is sprayed with fire-retarding chemical.

7. A product according to claim 1, wherein a grammar weight of the air-laid product is between 20 kg/m³ and 200 kg/m³.

8. A product according to claim 1, wherein the first portion comprises 80-90% by weight and the second portion comprises 10-20% by weight of the total fiber composition.

9. A method of manufacturing a non-woven product by dry forming a product of fibrous material, said method comprising:
advancing fibrous material into a forming box having a bottom outlet positioned over a forming wire to form a web of dry-laid fibers on the forming wire, where said fibrous material comprises:
a first portion of up to 98% recycled shredded material, where the shredded material is a mixture of shredded fabric material fibers from automotive tires and residues of rubber and other components from the shredded tires, and
a second portion of 1-30%, bi component fibers with a length between 2-50 mm and comprising a core and an outer sheathing, said outer sheathing having a first melting temperature which is lower than a second melting temperature of the core;
heating the web of fibers formed on the forming wire to a temperature above the first melting temperature; and
advancing the fibrous web through a pressing section whereby a fibrous product web with a predetermined density is formed.

10. A method according to claim 9, wherein a fluidized binder is sprayed into the forming box and onto the fibers therein.

11. A product according to claim 5, wherein the fire-retarding chemical comprises at least one of Borax, Boric acid, Ammonium sulphate, and aluminium sulphate.

12. A product according to claim 1, wherein the second portion is 1-5% bi-component fibers and wherein the fibers are between 2-6 mm in length.
